(19) United States
(12) Patent Application Publication
(10) Pub. No.: US 2026/0337531 A1
(43) Pub. Date: Oct. 29, 2026

(54) IMPREGNATED DRY SUBSTRATES AND VACUUM DRYING METHODS FOR WASHING AGENT RETENTION

(71) Applicant: Bernard Edward Ross, Vancouver (CA)

(72) Inventor: Bernard Edward Ross, Vancouver (CA)

(21) Appl. No.: 19/281,492

(22) Filed: Jul. 25, 2025

Related U.S. Application Data
(60) Provisional application No. 63/675,451, filed on Jul. 25, 2024.
(60) Provisional application No. 63/755,380, filed on Feb. 7, 2025.

(51) Int. Cl. C11D 17/06; C11D 11/00; C11D 17/04

(52) U.S. Cl. CPC C11D 17/06; C11D 11/00; C11D 17/046

(57) ABSTRACT

In one embodiment, an absorbent substrate, such as a fabric or sponge material, is impregnated with a liquid solution containing one or more washing agents, including but not limited to detergents, surfactants, lotions, or other chemical compositions. The substrate is allowed to absorb the solution and is then vacuum dried under controlled pressure and temperature conditions to substantially remove the liquid while preserving the active agents. The resulting vacuum-dried substrate is shelf-stable, activation-ready upon wetting, and suitable for use in cleaning, cosmetic, or therapeutic applications. Methods of manufacturing such substrates are also disclosed, along with the vacuum-dried products formed thereby.

### TECHNICAL FIELD

The present disclosure relates generally to impregnated dry substrates and methods of manufacture. More specifically, the invention relates to absorbent substrates such as cloths, fabrics, fibers, or sponges that are impregnated with washing agents or chemical compositions and vacuum dried to yield dry, shelf-stable products, and associated methods of manufacture.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Wash cloths, rags, sponges, and detergent sheets are useful for a variety of purposes such as cleaning dishes, clothes, hands, face and surfaces. Treating fibres, threads, yarns, fabrics or fibrous goods made from such materials and/or other suitable materials (such as sponges) with organic or inorganic substances or complexes thereof yields many useful applications.

Traditional methods for producing detergent cloths or pre-impregnated wipes have created wet versions of finished products that must then be heavily preserved for stability. Dry versions are less easily achieved and often involve heat drying or dehydration, which can degrade the chemical agents, distort substrate integrity, reduce shelf life, and increase the risk of combustion during manufacturing. Moreover, these methods generally require single-use plastic packaging to preserve the wet formula's stability. The need exists for improved processes that preserve the effectiveness of the impregnated agents while reducing environmental and safety risks.

### SUMMARY

The present invention addresses the aforementioned challenges by using vacuum drying to remove liquid (such as water) from a chemical solution applied to a substrate, while preserving the functional washing agents.

In one aspect, the invention provides a method for preparing a dry, shelf-stable detergent substrate by applying a washing agent-containing solution to a fabric or sponge, allowing the solution to absorb, and vacuum drying the treated substrate under controlled temperature and pressure.

In one aspect, there is described a method for preparing cleansing cloths, comprising applying a solution to a fabric sheet, the solution having at least one washing agent; and vacuum drying the fabric sheet to remove liquid from the fabric sheet.

In one aspect, there is provided a method of manufacturing an impregnated dry substrate, comprising applying a solution comprising at least one washing agent and a liquid carrier to an absorbent substrate, allowing the solution to absorb into the substrate for a dwell period, and vacuum drying the substrate by depressurizing to a pressure of approximately −0.09 MPa, and heating the substrate to a temperature of approximately 90 °C until such time as substantially all of the liquid carrier is removed and the washing agent is retained in the substrate.

In another aspect, the invention provides a product comprising a vacuum-dried absorbent substrate impregnated with at least one retained washing agent and free of water or other liquid carrier. The process increases shelf life, reduces the need for preservatives or plastic packaging, and improves safety and performance of the final product.

In accordance with another aspect of the present disclosure, there is provided a method for preparing cleansing cloths, including: applying a solution to a fabric sheet, the solution having at least one chemical or washing agent; and vacuum drying the fabric sheet using both air pressure and temperature to remove liquid from the fabric sheet. The vacuum drying process helps to: reduce fire hazards and material degradation compared to traditional dehydration; preserve the chemical composition and appearance of the substrate; extend the shelf life of the embedded composition, in some cases up to 25 years; eliminate the need for plastic or moisture-barrier packaging.

In accordance with an aspect, there is provided a vacuum dried detergent sheet (or substrate) comprising a sheet of fabric containing at least one chemical or washing agent.

In accordance with an aspect, there is provided a detergent sheet comprising a sheet of fabric having no water and containing at least one chemical or washing agent.

In one aspect, the invention provides a method of manufacturing an impregnated dry substrate (or sheet), comprising applying a liquid solution containing at least one washing or chemical agent to a substrate; allowing the substrate to absorb the solution for a selected time; vacuum drying the substrate by reducing the pressure to at least −0.09 MPa and applying a temperature of approximately 90 °C for a selected duration, such that most or all of the liquid is removed while the active agent remains embedded in the substrate.

In one aspect of the present invention, there is provided a vacuum-dried substrate comprising an absorbent material in sheet or sponge form, having no liquid content, an at least one washing agent retained within the material, wherein the substrate has been vacuum dried after impregnation with a solution comprising the washing agent.

In accordance with one aspect, the method of manufacture comprises the steps of cutting fabric to size or processing in bulk sheets, applying the solution via spraying or soaking for approximately 5 to 15 minutes with optional dwell period for absorption; vacuum depressurization to −0.09 MPa; drying at 90 °C for approximately 100 to 240 minutes; and re-pressurizing and testing moisture levels. Alternative drying conditions and agent concentrations may be used based on the active agent type.

In another aspect, the invention provides a dry, vacuum-treated detergent sheet comprising: an absorbent substrate having no remaining liquid; one or more retained chemical or washing agents embedded within the substrate matrix.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a schematic diagram of a cleansing substrate receiving a washing agent-containing solution, in accordance with some embodiments; and

FIG. 2 is a flow diagram of a method for preparing a vacuum-dried cleansing substrate, including solution application and vacuum drying phases, in accordance with some embodiments.

### DETAILED DESCRIPTION OF EMBODIMENTS

In the following description, for the purposes of explanation, numerous specific details are set forth in order to provide a thorough understanding of the present invention. It will be apparent, however, that the present invention may be practiced without these specific details.

The principles, uses and implementations of the teachings herein may be better understood with reference to the accompanying description and figures. Upon perusal of the description and figures present herein, one skilled in the art is able to implement the invention without undue effort or experimentation. In the figures, like reference numerals refer to like parts throughout.

Before explaining at least one embodiment in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

Additional objects, features and advantages of the invention will be set forth in the detailed description which follows, and in part will be readily apparent to those skilled in the art from the description or recognized by practicing the invention as described in the written description and claims hereof, as well as the appended drawings. Various features and sub-combinations of embodiments of the invention may be employed without reference to other features and sub-combinations.

It is to be understood that both the foregoing general description and the following detailed description, including the materials, methods and examples, are merely exemplary of the invention, and are intended to provide an overview or framework to understanding the nature and character of the invention as it is claimed, and are not intended to be necessarily limiting.

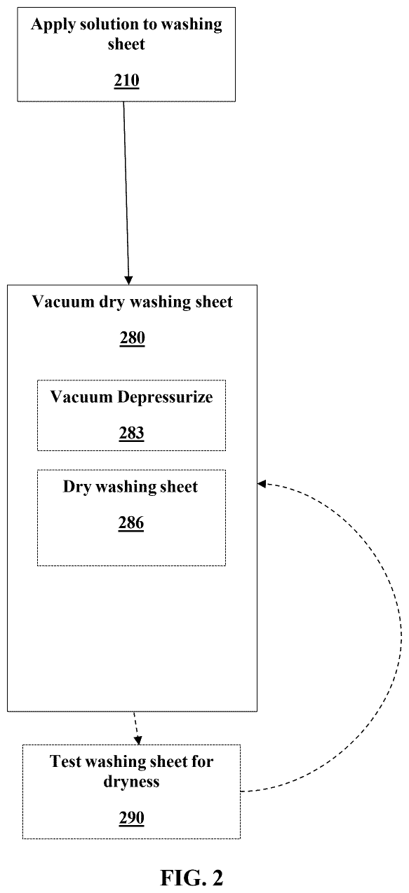

Referring now to the drawings, in the example embodiments shown, FIG. 2 shows an absorbent substrate (100), which may be a nonwoven fabric sheet, sponge, cellulose pad, or synthetic textile, being impregnated with a solution (110) containing one or more washing agents (120). In some embodiments, solution 110 is applied by spraying or soaking. The washing agents 120 may include one or more of: surfactants, detergents, soaps, bleaches, solvents, fabric softeners, moisturizers, disinfectants, or any other suitable active ingredients. These are intended as non-limiting examples only. Further, the term “washing agents” is used because it is anticipated that many of the applications of the inventive apparatus will involve “washing” or “cleaning”, however, use of the term “washing” is not intended to limit the active ingredients which could be used (including active ingredients for uses unrelated to washing or cleaning, such as, moisturizers or sunscreens).

FIG. 2 illustrates an example method of preparing the vacuum-dried substrate. At step 210, the substrate 100 is exposed to the solution 110 via spraying or soaking. At step 220, the treated substrate is allowed to rest for a dwell time (typically 5 to 15 minutes) to ensure proper absorption. At step 230, the substrate is transferred to a vacuum dryer. In this example, the chamber is depressurized (step 283) to about −0.09 MPa and heated (step 286) to approximately 90 °C for a duration ranging from approximately 100 to 240 minutes. In some embodiments, these values may be adjusted depending on the chemical composition or desired dryness threshold. In one example embodiment of this method, the chamber is depressurized from about −0.08 MPa to 1.0 MPa and the temperature ranges from about 60 to 140 °C, and the time ranges from about 70 to 240 mins. Heating at a lower temperature will necessitate a longer drying time.

Following drying, the pressure is normalized, and the substrate is tested (step 290) for moisture content. Optionally, the substrate may be cut to the final product size before or after the drying process (steps 205, 295).

The vacuum drying process offers several technical advantages: reduces heat damage and fire risk compared to conventional dryers; maintains colour, texture, and structural integrity of the substrate; preserves chemical efficacy of the impregnated agents; extends shelf life, potentially up to 25 years; and eliminates the need for wet packaging or preservatives. Optionally, stabilizers (or binders) can be used to improve drying uniformity and/or agent retention.

In some embodiments, the process of vacuum drying an impregnated fabric allows for the elimination of single use plastic packaging for the fabric. A cleansing cloth 100 can be an impregnated fabric or sponge, for example.

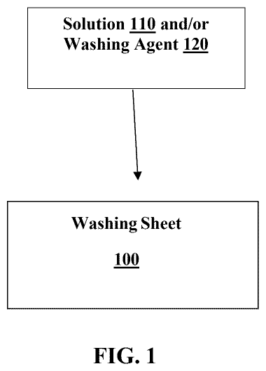

Referring to the drawings, FIG. 1 shows an example cleansing cloth 100 receiving a solution 110, in accordance with some embodiments. While reference is made to the term cleansing cloth throughout this disclosure, the material need not be a cloth and the substance 20 (or solution) impregnated in the material need not be a cleaner or cleanser. In various embodiments, a cleansing cloth 100 can be a sheet made of fabric, a material that is not in sheet form, a material that is in sheet form, a material that is not a fabric, or a material that is a fabric. Cleansing cloth 100 can be made of a material that is flexible in some embodiments. Cleansing cloth 100 can be a fabric sheet, for example. In some embodiments, cleansing cloth 100 includes a solution 110 and/or washing agent 120. Solution 110 and/or washing agent (chemical agent; sunscreen, etc.) 120 can be, for example, a surfactant package.

The cleansing cloths need not be technically cloths or comprised of cloth materials, or traditional cloth materials. In addition, in some embodiments, the cleansing cloths can be impregnated with a detergent. In other embodiments, the cleansing cloths can be impregnated with any of a range of different substances, solutions and/or compositions, including but not limited to washing agents, detergents, fabric softeners, bleaches, lotions, sunscreens, moisturizers, polishing agents, makeup removers, makeup, polishing agents, bug repellants, abrasives, water repellants, etc. The solution 110 can be absorbed in cleansing cloth 100, for example. Examples of solution 110 or washing agent 120 include one or more hand dishwashing products, automatic dishwashing products, laundry detergents, stain removers, bleach, hard surface cleaners, window or glass cleaners, grease removers, hand soaps, body wash, eye makeup removers, disinfectants, chemicals, surfactant, soap, detergent, bleach, solvent, moisturizer, polishing agent, repellent, sunscreen, fabric softening agent, cleansing agent or formula, or a combination of same. Cleansing cloth 100 may be used for washing or cleaning in some embodiments or, in some embodiments, not for washing or cleaning. The purpose for which cleansing cloth 100 is used can be selected based on the selection of solution 110 and/or washing agent 120. Solution 110 can include one or more washing agents 120. Solution 110 can include a liquid such as water. The one or more washing agents 120 can be dissolved, mixed, suspended, or otherwise carried by the liquid.

FIG. 2 shows an example method for preparing cleansing cloth 100, in accordance with some embodiments. In some embodiments, cleansing cloth 100 is a fabric sheet or a sponge.

At 210, a solution 110 is applied to cleansing cloth 100, the solution 110 having at least one washing agent 120; and, at 280, the cleansing cloth 100 is vacuum dried by being mechanically depressurized to −0.09 Mpa (at 283) and then, at 286, dried at a temperature of 90 °C for 100 to 240 minutes. In other embodiments, a different temperature, pressure, and/or different duration is used.

The at least one washing agent 120 can be a surfactant, soap, detergent, bleach, solvent, softening, cleansing, scouring agent or formula, or a combination of one or more of same. The at least one washing agent 120 can include other chemicals. Solution 110 and/or washing agent 120 can be selected based on the purpose for which cleansing cloth 100 is used.

In some embodiments, solution 110 is applied to cleansing cloth 100 by submerging cleansing cloth 100 in solution 110. For example, cleansing cloth 100 can be placed in a tray containing solution 110 and/or washing agent 120. The application of solution 110 to cleansing cloth 100 can be performed for about 5 to about 10 minutes, in some embodiments, with up to 20 times the weight of the fabric or material itself.

In some embodiments, solution 110 is applied to cleansing cloth 100 by spraying cleansing cloth 100 with solution 110. In some embodiments both application methods are used.

In some embodiments, optionally, solution 110 is allowed to be absorbed in cleansing cloth 100 for a threshold period of time before the vacuum drying process is performed. For example, the threshold period of time can be about 5 minutes to about 15 minutes or more than 15 minutes. The amount of time can be selected based on the type of solution 110 and/or washing agent 120.

In some embodiments, the vacuum drying removes all liquid from cleansing cloth 100 and leaves the at least one washing agent 120 in cleansing cloth 100. In some embodiments, only an amount of liquid is removed up to a threshold level. For example, in some embodiments, at 290, cleansing cloth 100 is tested for a threshold level of dryness and cleansing cloth 100 is vacuum dried until the threshold level of dryness is reached. The vacuum drying can remove liquid from cleansing cloth 100 until a threshold level of dryness is reached. In some embodiments, the vacuum drying includes a vacuum depressurization step 283 and a drying step 286 as shown in FIG. 2.

Cleansing cloth 100 can be cut or otherwise processed to a desired configuration such as size before solution 110 is applied to cleansing cloth 100 or, in some embodiments, after it is vacuum dried.

After this process, in some embodiments, cleansing cloth 100 is a vacuum dried detergent sheet that is made of fabric or sponge and includes at least one washing agent 120. The at least one washing agent 120 can be a surfactant, soap, detergent, bleach, solvent, softening agent, cleansing, polishing agent or formula, chemical, or a combination of one or more of same.

After this process, in some embodiments, substrate or cleansing cloth 100 is a detergent sheet comprising a fabric sheet or sponge having no liquid and containing at least one chemical or washing agent. The at least one washing agent can be a surfactant, soap, detergent, bleach, solvent, softening agent, cleansing, polishing agent or formula, chemical, or a combination of one or more of same.

As used herein, the terms “about” and “approximately” (and roots and variations of these terms) refer to an approximately +/−10% variation from a given value. It is to be understood that such a variation is always included in any given value provided herein, whether or not it is specifically referred to.

To gain a better understanding of embodiments described herein, the following examples are set forth. It will be understood that these examples are intended to describe illustrative embodiments and are not intended to limit the scope of the present disclosure in any way.

### NON-LIMITING EXAMPLES

Aspects of the teachings herein were experimentally demonstrated.

Example 1 summary: A cotton fabric is soaked in a detergent solution containing 15% surfactant and allowed to rest for 10 minutes. The fabric is then vacuum dried at −0.09 MPa and 90 °C for 120 minutes. The result is a dry, shelf-stable detergent cloth that reactivates upon contact with water, and can be used as a laundry detergent.

Example 2 summary: A synthetic sponge is sprayed with a window cleaning solution containing 5% ammonia and 10% isopropanol. The treated sponge is vacuum dried at 95 °C for 130 minutes. The final product can be packaged without a plastic wrap and used for streak-free glass cleaning.

### Example 1

At step one, a synthetic or non-synthetic fabric can either be cut to the correct desired finished size or treated first in larger format bolts of fabric, and then cut to size after the procedure.

At step two, the fabric is placed in or on a tray or table to allow for soaking or wetting, by means of spraying or submerging in the desired solution.

At step three, the fabric is sprayed with or the fabric is soaked with a specific percentage of surfactant, soap, detergent, bleach, solvent, softening or cleansing formula.

At step four, the liquid formula is allowed to be absorbed for an approximately 5-15 minute period of time. This length of time can be adjusted for certain chemicals.

At step five, a machine is employed which can depressurize air pressure to −0.09 Mpa (megapascal-atmospheric typically 0.1013). Depressurization is achieved by an attached pump. The temperature is set to achieve 90 °C. Start time to heat from ambient temperature is approx. 110 mins. In other embodiments, a different temperature, pressure, and/or different duration is used.

At step six, 90 °C temperature is achieved, and maintained for a minimum of about 120 minutes.

At step seven, after the vacuum drying process is completed, at about 110 to 140 mins @90 °C, the machine's vents are slowly opened to neutralize air pressure. Once pressure is neutralized, the doors can be opened and the detergent sheets removed.

At step eight, the fabric is tested for dryness.

At step nine, the dried pieces or bolt of fabric is removed from the tray.

At step ten, the fabric is packaged and, if not yet cut, cut to the desired size(s) and number(s) of fabric sheets.

### Example 2

At step one, the non-synthetic or synthetic or synthetic blend of fabrics are cut to the correct desired size.

At step two, the pieces of fabric are placed on a soaking/wetting tray/table.

At step three, the fabric is sprayed or otherwise soaked with a specific percentage of surfactant, soap, detergent, or liquid chemical mix, up to 20 times the weight of the fabric itself. This is performed from about 5-10 minutes. Application is done at room temperature 20-25 °C.

At step four, the detergent mix is allowed to be absorbed for a period of time, such as 5-15 minutes.

At step five, the vacuum chamber is prepared and cleaned, with all noticeable moisture wiped from the inner door to help ensure a proper seal. The vacuum dryer is turned on for preparation if not already on.

At step six, the fabric is moved into a vacuum drying process to remove all the water (see e.g., at 280 in FIG. 2). The wet fabric sheets are placed in dryer trays, which are placed in the vacuum dryer, for the vacuum drying depressurization pre-phase. The machine door is closed, and the vacuum depressurization phase is initiated (see e.g., at 283 in FIG. 2). The air vents are set to the closed position, the vacuum valve is switched on, and the machine is run for about 1 minute. At the start, typical atmospheric pressure is 0.10113 Mpa. Depressurization is ended when vacuum pressure reaches −0.09 Mpa. The vacuum is then switched off, and the vacuum pump is also turned off. The machine is then activated for processing (vacuum drying) at about 110 minutes at 90 °C. The total to heat and dry process takes about 130-140 minutes.

At step seven, the fabric sheets are then dried (see e.g., at 286 in FIG. 2). The drying process is activated when the machine is powered on and the temperature and time are set to 120 minutes at 95 °C. The total time for this heat and dry process takes approximately 130 to 170 minutes.

Next, in a vacuum drying phase, dependent upon the ambient temperature, the heating takes approximately 60 to 90 minutes to reach the set temperature of 95 °C. After this temperature is reached, the timing countdown will start from the set time of 120 minutes, and the temperature will be maintained at 95 °C for the duration of 120 minutes.

The process ends when the timer hits 0. The fabric can be cooled immediately following this stage.

In some embodiments, the starting temperature can be varied and the heating duration adjusted accordingly such that the heating ends when the temperature reaches the threshold temperature, such as 194 °F (90 °C).

After the drying process is completed, the vacuum dryer is turned off, the air vent is slowly opened to create equal pressure. The vacuum reading will indicate when the pressure has been neutralized to 0, and the door can be slowly opened. The trays containing the fabric sheets are removed from the machine.

At step eight, the fabric sheets are tested for dryness, using a moisture meter (see e.g., at 290 in FIG. 2).

At step nine, the dried pieces are removed from the tray.

At step ten, the fabric pieces are packaged.

In some embodiments, the methods described herein using vacuum drying to produce cleansing cloth 100 has benefits over using dehydration for a variety of reasons. For example, the process of dehydrating can negatively affect the colour and performance of the material (e.g., fabric) used. In contrast, vacuum drying fabric can preserve all the chemistry (e.g., washing agent) added to the material (e.g., fabric) and can help the fabric look and perform the same as or similarly to before the material was treated.

Further, the method using vacuum drying can help maintain a longer shelf life for cleansing cloth 100 produced. For example, many washing agents 120 such as soaps and detergents have a short shelf life (e.g., approximately 3 years). In contrast, vacuum dried fabric containing washing agent(s) 120 can last up to about 25 years and may not need to be to be rotated like other soaps and detergents to protect from the growth of molds and bacteria.

Additionally, the method using vacuum drying can cause only up to a very small amount of damage to the material (e.g. fabric, sponge). Nearly all of the ingredients (e.g. washing agents 120), including the chemistry of such ingredients, applied to the fabric prior to being vacuum dried can be preserved. In contrast, other preservation methods (such as the addition of preservation ingredients) can alter the end product's look, feel, performance, and stability.

Still further, dehydrating or heat drying can affect the colour and texture of the finished fabric, causing the end product to look and feel very different and unattractive. The method using vacuum dried fabric, in contrast, can be more similar in appearance to how the fabric appeared before the process.

Prior testing was performed using a blow dryer, heat gun, or flash dryer screen printing machine and compared to methods described herein using vacuum drying to produce cleansing cloths 100.

It was found that using a blow dryer or heat gun was ineffective and caused damage to sample sheets.

Using a flash dryer uses a high sustained heat for drying and this elevated temperature can cause many of the sample sheets (various surfactant packages, etc.) to be damaged, such as brittle scarred. In some cases, since the temperature is so high and focused directly at the samples-some were overheated to beyond what fabric sheets could tolerate and sometimes beyond what the surfactant package could withstand, creating a dangerous environment, which could lead to a fire. Some of the samples started smoking due to too much heat being applied to the surfactant package. Some samples started to burn due to the sheets becoming overheated and reaching a combustible temperature.

Embodiments of methods described herein that use vacuum drying to produce cleansing cloths 100 can reduce the potential for fire, both for the surfactant package (since each surfactant has its own flash point or combustible temperature) and the flash point or combustible temperature for the fabric sheet. This can lead to a safer method for producing cleansing cloths 100. Heat related issues or fire can be contained and/or reduced. For example, samples are processed at a lower temperature and then dried at a lower temperature with the use of the described vacuum method. As a result, samples are not affected in the way that they would be using a blow dryer, heat gun, or flash drying and damage is reduced or eliminated. Further, the method is safer for personnel overseeing or handling the method, and the working environment is safer.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

What is claimed is:

1. A method of manufacturing an impregnated dry substrate, comprising:
applying a solution comprising at least one washing agent and a liquid carrier to an absorbent substrate;
allowing the solution to absorb into the substrate for a dwell period; and
vacuum drying the substrate by:
depressurizing to a pressure of at least −0.08 MPa; and
heating the substrate to a temperature of at least 60 °C until substantially all of the liquid carrier is removed and the washing agent is retained in the substrate.

2. The method of claim 1, wherein the at least one washing agent is a surfactant, soap, detergent, bleach, solvent, softening agent, cleansing agent or formula, chemical, or a combination of one or more of same.

3. The method of claim 1, wherein the applying is by submerging the substrate in the solution.

4. The method of claim 1, wherein the applying is by spraying the substrate with the solution.

5. The method of claim 1, wherein the vacuum drying removes all liquid from the substrate and leaves the at least one washing agent in the substrate.

6. The method of claim 1, further comprising cutting the substrate to a desired size before the applying of the solution to the substrate.

7. The method of claim 1, further comprising cutting the substrate to a desired size after the vacuum drying.

8. The method of claim 1, further comprising testing the substrate for a threshold level of dryness and vacuum drying the substrate until the threshold level of dryness is reached.

9. The method of claim 1, wherein the vacuum drying removes liquid from the substrate until a threshold level of dryness is reached.

10. The method of claim 1, further comprising testing the substrate for the threshold level of dryness and vacuum drying the substrate until the threshold level of dryness is reached.

11. The method of claim 1, further comprising allowing the solution to be absorbed in the substrate for a threshold period of time before the vacuum drying.

12. A method of manufacturing an impregnated dry substrate, comprising:
applying a solution comprising at least one washing agent and a liquid carrier to an absorbent substrate;
allowing the solution to absorb into the substrate for a dwell period; and
vacuum drying the substrate by:
depressurizing to a pressure of approximately −0.09 MPa, and
heating the substrate to a temperature of approximately 90 °C until substantially all of the liquid carrier is removed and the washing agent is retained in the substrate.

13. The method of claim 12, wherein the washing agent comprises one or more of: a surfactant, detergent, soap, bleach, fabric softener, moisturizer, or disinfectant.

14. The method of claim 12, wherein the solution is applied by spraying, soaking, or a combination thereof.

15. The method of claim 12, further comprising cutting the substrate to a desired shape either before or after vacuum drying.

16. The method of claim 12, further comprising testing the substrate for a threshold moisture content and continuing vacuum drying until the threshold is met.

17. The method of claim 12, wherein the substrate is a fabric, sponge, or synthetic sheet.

18. A vacuum-dried substrate comprising:
an absorbent material in sheet or sponge form, having no liquid content; and
at least one washing agent retained within the material,
wherein the substrate has been vacuum dried after impregnation with a solution comprising the washing agent.

19. The substrate of claim 18, wherein the washing agent is selected from the group consisting of surfactants, soaps, detergents, bleaches, solvents, fabric softeners, moisturizers, disinfectants, or combinations thereof.

20. The substrate of claim 18, wherein the substrate comprises nonwoven fabric or cellulose sponge.
